(19) United States
(12) Patent Application Publication
(10) Pub. No.: US 2005/0057500 A1
(43) Pub. Date: Mar. 17, 2005

(54) Display and pointer manipulation using relative movement to a device

(76) Inventor: David D. Bohn, Ft. Collins, CO (US)

Correspondence Address: HEWLETT-PACKARD COMPANY;Intellectual Property Administration, P.O. Box 272400, Fort Collins, CO, 80527-2400, US

(21) Appl. No.: 10/966,008

(22) Filed: Oct. 14, 2004

Related U.S. Application Data
(63) Continuation of application No. 09/471,810, filed on Dec. 17, 1999.

(51) Int. Cl. G09G 5/00

(52) U.S. Cl. 345/158

(57) ABSTRACT

Mouse-like functions of smooth, non-orthogonal movement of cursors, scrolling, panning, and navigating are provided on a handheld device without a detached or semi-detached mouse-like or stylus-like part. Existing graphical user interfaces are used on handheld devices without redesigning the workflow or defining special keys for navigating a cursor or selecting graphical objects. Navigation sensors on a handheld device with a display to detect and measure relative motion of a surface in front of the navigation sensor. This relative motion is then used to move a cursor on the display, or pan or otherwise navigate what is shown on the display. The navigation sensors are placed on the opposite side of the device as the display or on the bottom of a two part hinged device. This allows the user to slide the device around the surface it is placed on to manipulate the display while viewing the display. The user may also move a finger or other body part in front of the navigation device to manipulate the display while viewing the display. The navigation sensors may also serve a dual function. The first function is to aid in the capture of a scanned image by a handheld scanner. Then, after an image has been acquired, the same navigation sensors are used to manipulate the display.

### REFERENCE TO RELATED DOCUMENTS

This application is related to the subject matter described in the following two U.S. Pat. Nos. 5,578,813 filed 2 Mar. 1995, issued 26 Nov. 1996 titled FREEHAND IMAGE SCANNING DEVICE WHICH COMPENSATES FOR NON-LINEAR MOVEMENT; and 5,644,139, filed 14 Aug. 1996, issued 1 Jul. 1997 titled NAVIGATION FOR DETECTING MOVEMENT OF NAVIGATION SENSORS RELATIVE TO AN OBJECT. Both of these Patents have the same inventors: Ross R. Allen, David Beard, Mark T. Smith and Barclay J. Tullis, and both Patents were, at the time that the invention that is the subject of this application was made, owned by the same entity or subject to an obligation of assignment to the same entity. This application is also related to the subject matter described in U.S. Pat. No. 5,786,804 issued 20 Jul. 1998, titled METHOD AND SYSTEM FOR TRACKING ATTITUDE, and pending divisional application based on the aforementioned issued patent Ser. No. 09/022097, and U.S. patent application Ser. No. 09/052046, HP docket number 10980359-1 filed 30 Mar. 1998, titled SEEING EYE MOUSE FOR A COMPUTER SYSTEM, all of these were, at the time that the invention that is the subject of this application was made, owned by the same entity or subject to an obligation of assignment to the same entity. The three patent documents describe techniques of tracking position movement and computer pointing devices. Those techniques and devices are components in the preferred embodiment described below. Accordingly, U.S. Pat. Nos. 5,578,813, 5,644,139, and 5,786,804 are hereby incorporated herein by reference. The related application Ser. No. 09/022097 describes a computer mouse based on those techniques, therefore U.S. patent application Ser. No. 09/022097, HP docket number 10980359-1 filed 30 Mar. 1998, titled SEEING EYE MOUSE FOR A COMPUTER SYSTEM is hereby incorporated herein by reference.

### FIELD OF THE INVENTION

This invention relates generally to controlling a cursor, or scrolling, on a display screen. This invention relates even more particularly to methods and apparatus for controlling a cursor or scrolling on small handheld devices.

### BACKGROUND OF THE INVENTION

The use of a hand operated pointing device for use with a computer or other electronic device and its display has become almost universal. By far the most popular of the various devices is the mouse. More recently, portable computers and personal digital appliances (PDA's) have become available that are small enough to be handheld. Because a mouse is typically designed to fit comfortable in a human hand, mice are relatively large when compared to the size of these handheld devices. Accordingly, these handheld sized devices may use a pen-like stylus, touch screen, buttons, and other things to manipulate a cursor, or control scrolling functions. One example of this is the HP CapShare 920 portable e-copier available from Hewlett-Packard, Co., Palo Alto, Calif. This device is a handheld scanner that includes a small liquid-crystal display (LCD) screen for displaying menus, dialog boxes, and previews of the scanned image. The user interfaces with these menus, etc. by pressing various buttons located on the device. For example, to scroll the preview of the scanned image to the left, the user presses a button shaped like a leftward pointing arrow. Another example of a handheld sized device is the HP Jornada 420 palm-sized PC available from Hewlett-Packard, Co., Palo Alto, Calif. This device has an LCD screen and five buttons for powering on or off, recording, scrolling though and selecting text and pulling up a START menu.

Unfortunately, multiple buttons with multiple functions, and styluses, lack some of the advantages that a mouse provides. For example, the graphical user interfaces (GUI's) associated with some of the most popular operating systems are easiest to learn and operate with a moving cursor controlled by a mouse (or trackball, etc.). A typical function performed with these systems is the selection of a single icon from a distributed field of icons. With multiple buttons, this function may require multiple button presses that select successive icons in orthogonal directions. When the desired icon is finally selected, yet another button must be pressed to activate the desired icon and perform some operation. In contrast, a free-floating mouse-type and cursor system only requires a natural sliding motion performed with one hand to move the cursor and a single button press on the mouse to perform the operation. Another function performed with these systems is scrolling, panning, and navigating to view portions of a document that are not currently shown. With multiple buttons, each scroll, pan, or navigation is often done in discrete, predetermined, orthogonal, intervals. A free-floating mouse-type system can provide smoother movements in non-orthogonal directions that are more natural to use. Accordingly, there is a need in the art for an improved pointing interface device and method that is suitable for use with handheld devices. Such an interface should provide the intuitive feel and familiarity of a mouse-based system without increasing the size or disrupting the unity of package of a handheld device. Such an interface should also provide an intuitive way of scrolling, panning, or performing other navigation functions. Finally, the interface should try to minimize the number of buttons on a handheld device because of cost and usability concerns.

### SUMMARY OF THE INVENTION

The invention provides mouse-like functions of smooth, non-orthogonal movement of cursors, scrolling, panning, and navigating on a handheld device without a detached or semi-detached mouse-like or stylus-like part. By providing mouse-like functions, the invention preserves the intuitive feel and familiarity of a mouse based systems on a handheld device. The invention may be implemented with no moving parts, and a minimum number of buttons to perform the functions of the buttons on a mouse. Finally, the invention allows existing graphical user interfaces to be used on handheld devices without redesigning the workflow or defining special keys for navigating a cursor or selecting graphical objects.

An embodiment of the invention uses navigation sensors on a handheld device with a display to detect and measure motion of that device relative to a surface in close proximity to the navigation sensor. This relative motion may be created by moving the entire device around a surface on which the device is place, or it may be created by moving a finger or other body part in front of the navigation sensor. The relative motion of the device is then used to move a cursor on the display, or pan or otherwise navigate what is shown on the display. In one embodiment, the navigation sensors are placed on the opposite side of the device as the display. This allows the user to slide the device around the surface it is placed on to manipulate the display while viewing the face-up display. In another embodiment, the navigation sensors are placed on the bottom of a two part hinged device. This allows the user to slide the device around the surface it is placed on to manipulate the display that is conveniently angled for viewing by the hinge. In another embodiment, the navigation sensors serve a dual function. The first function is to aid in the capture of a scanned image by a handheld scanner. Then, after an image has been acquired, the same navigation sensors are used to manipulate the display.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of a handheld digital appliance with attached display.

FIG. 2A is an illustration of a two part hinged device with attached display in an open position.

FIG. 2B is an illustration of a two part hinged device with attached display in a closed position.

FIG. 3 is an illustration of a handheld scanning device with attached display.

FIG. 4 is an illustration of a handheld scanning device with an attached display located on the top of the device.

### DETAILED DESCRIPTION OF THE PREFERRED EMBODIMENTS

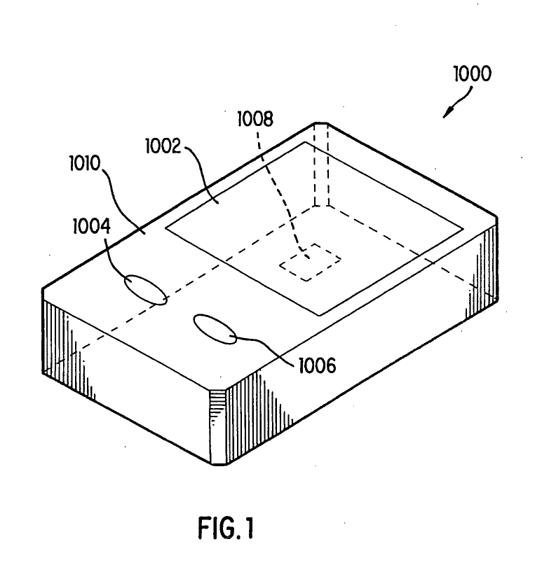

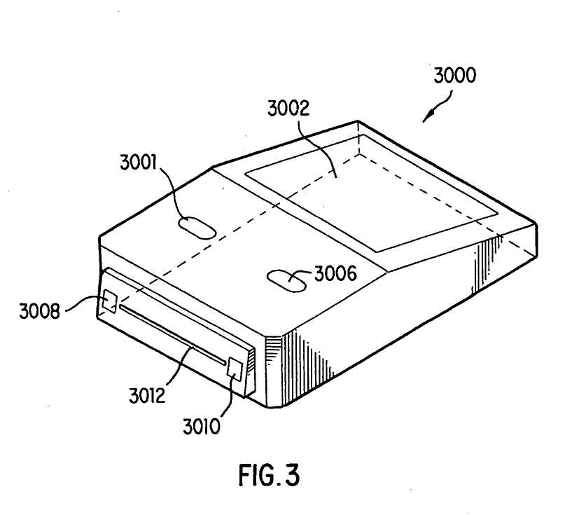

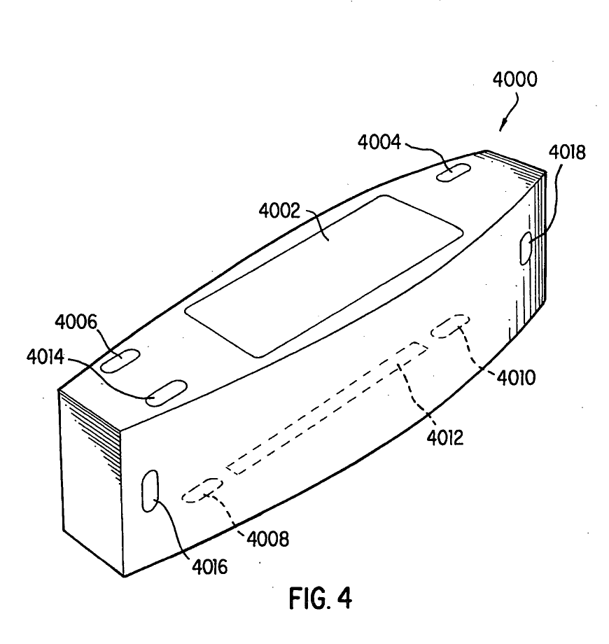

FIGS. 1-4 show handheld electronic devices useful for performing any of multiple computing, business, entertainment, and communication tasks. In addition, FIG. 3 and FIG. 4 show electronic devices that are also useful for scanning an image-bearing surface. In FIG. 1, the electronic device 1000 includes a display 1002 and two buttons 1004, 1006 located on a top surface 1010. Located on a bottom surface is a navigation sensor 1008. Navigation sensor 1008 is used to track the movement of the device 1000 relative to a surface upon which the device is placed. Navigation sensors of several types are disclosed and described in the documents mentioned above in the section REFERENCE TO RELATED DOCUMENTS. Accordingly, those documents mentioned above in that section are hereby incorporated herein by reference.

Navigation sensor 1008 effectively observes a moving image of the surface in front of navigation sensor 1008. This motion may be created by placing device 1000 upon a surface and moving the entire device, or by moving a part of the user in front of navigation sensor 1008. Navigation sensor 1008 produces an indication of the displacement in two planar dimensions between successive observations. This indication of displacement is used by device 1000 to manipulate what is shown on display 1002. For example, the indications of displacement may be used by device 1000 to control a cursor that is shown on display 1002. In this manner, the user may move device 1000 which would, in turn, move the position of a cursor shown on display 1002. This coordination of device movement to cursor movement could then be used with a graphical user interface (GUI) and buttons 1004 and 1008 to control the operation of device 1000 much like the movement of a mouse controls the operation of a GUI on a desktop personal computer.

The indications of displacement may also be used to perform other functions that manipulate what is shown on display 1002. For example, the indications of displacement may be used to control panning, scrolling, or other image navigation functions. This would allow the user to move the device 1000 in a desired direction to see regions of an image that are not presently displayed on display 1002. This provides the user a natural feel for these operations that is similar to moving a magnifying glass over an area of interest.

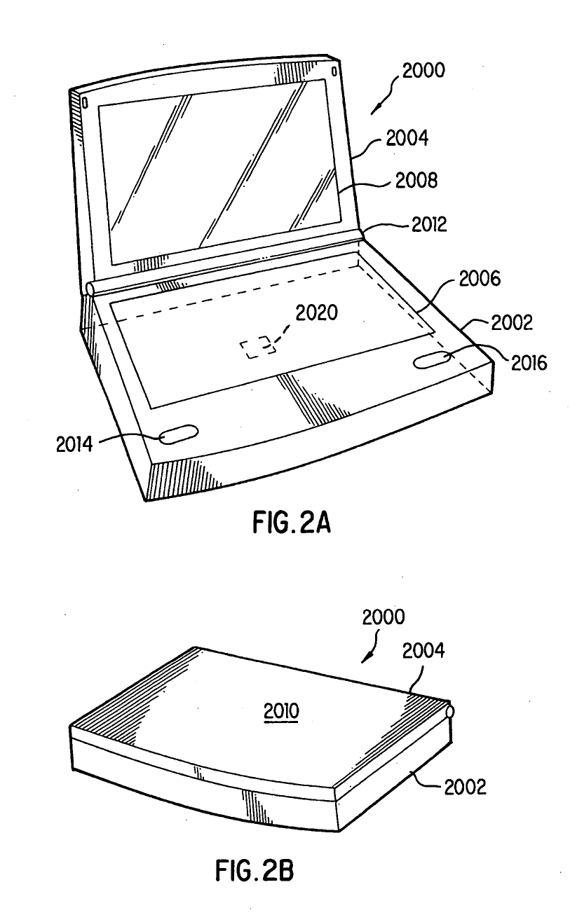

In FIG. 2A and 2B, the electronic device 2000 includes a system unit 2002 and a display unit 2004. The system unit 2002 includes a keyboard 2006, buttons 2014, 2016, and navigation sensor 2020. Navigation sensor 2020 shown located on the bottom surface of system unit 2002. Keyboard 2006 and buttons 2014, 2016 are shown located on the top surface of system unit 2002. The display unit 2004 includes display panel 2008 and display panel housing 2010. The display unit 2004 is attached to the system unit 2002 and rotates on hinge 2012 between an open position (shown in FIG. 2A) and a closed position (shown in FIG. 2B). Navigation sensor 2020 effectively observes a moving image of the surface in front of navigation sensor 2020. This motion may be created by placing device 2000 upon a surface and moving the entire device, or by moving a part of the user in front of navigation sensor 2020. This relative movement can be used to manipulate what is shown on the display 2008 and control the device 2000 as described above.

FIG. 2A and 2B show buttons 2014 and 2016 located on the top surface of system unit 2002. This would allow the user to grasp the system unit between the thumb and middle finger and use the index finger to press buttons 2014 and 2016. However, this is just one of many possibilities. Buttons 2014 and 2016 may be located in other positions and other surfaces or may be not included in the device completely. For example, if buttons 2014 and 2016 are not included, then the user may perform the same functions by pressing certain keys on keyboard 2006 with an index finger. Another possibility is to locate buttons 2014 and 2016 on the front vertical surface of system unit 2002. This would allow the user to grasp the unit between the thumb and index finger and press these buttons with a thumb.

FIG. 3 is an illustration of a handheld scanning device 3000 with attached display 3002. The scanning device 3000 includes a display 3002 that may provide almost immediate viewing of a captured image. Scanning device 3000 also includes buttons 3004 and 3006. Buttons 3004 and 3008 can be used to aid in interfacing with a GUI, image capture, or image navigation.

In FIG. 3, the forward side of the scanning device 3000 includes navigation sensors 3008 and 3010 and imaging sensor array 3012. Typically, when the device is being used to scan an image, this forward side is placed toward the image to be captured and the device is moved around the image to capture it. In this position, the navigation sensors 3008 and 3010 are in close proximity to the surface with the image on it and are able to effectively observe a moving image of the surface device 3000 is placed upon and produces an indication of the displacement in two planar dimensions between successive observations. Also, display 3002 is angled slightly off perpendicular with this forward side to improve the viewability of display 3002 when device 3000 is in this position.

Device 3000 uses navigation sensors 3008 and 3010 to manipulate a GUI or scroll through an image while viewing display 3002. Navigation sensors 3008 and 3010 are also used during image capture. This allows the function of one or more of the navigation sensors 3008 and 3010 to be shared between display manipulation and image capture without additional hardware. It also allows capture verification to be very intuitive. To verify the image capture, the user would place the forward side in FIG. 3, against a surface and move it around. Alternatively, the user could hold the device and move a finger or other body part over at least one of the navigation sensors 3008 and 3010. The display 3002 would appear to the user to be moving around the captured image. One of buttons 3004 and 3006 could be used to activate a navigate mode that moves a captured image around the display in response to the movement of device 3000 or movement of the users finger. Finally, since most GUI and scrolling functions do not require the positional accuracy that scanning does, the indications of displacement produced by navigation sensors 3008 or 3010 may be downsampled. This would reduce the compute requirements associated with handling the indications of displacement when an image was not being captured.

FIG. 4 is an illustration of a handheld scanning device 4000 with attached display 4002 on the top of the device. The scanning device 4000 includes a display 4002 on the top of the device that may provide almost immediate viewing of a captured image. Scanning device 4000 also includes buttons 4004, 4006, and 4014 on top of the device. Buttons 4016 and 4018 are shown positioned on a vertical side of scanning device 4000. Any of buttons 4004, 4006, 4014, 4016, and 4018 can be used to aid in interfacing with a GUI, image capture, or image navigation.

In FIG. 4, the botton side of the scanning device 4000 includes navigation sensors 4008 and 4010 and imaging sensor array 4012. Typically, when the device is being used to scan an image, this bottom side is placed toward the image to be captured and the device is moved around the image to capture it. In this position, the navigation sensors 4008 and 4010 are in close proximity to the surface with the image on it and are able to effectively observe a moving image of the surface device 4000 is placed upon and produces an indication of the displacement in two planar dimensions between successive observations. Also, display 4002 may angled slightly off level to improve the viewability of display 4002 when device 4000 is in this position.

Device 4000 uses navigation sensors 4008 and 4010 to manipulate a GUI or scroll through an image while viewing display 4002. Navigation sensors 4008 and 4010 are also used during image capture. This allows the function of one or more of the navigation sensors 4008 and 4010 to be shared between display manipulation and image capture without additional hardware. It also allows capture verification to be very intuitive. To verify the image capture, the user would place the bottom side in FIG. 4, against a surface and move it around. Alternatively, the user could hold the device and move a finger or other body part over at least one of the navigation sensors 4008 and 4010. The display 4002 would appear to the user to be moving around the captured image. One of buttons 4004, 4006, 4014, 4016, and 4018 could be used to activate a navigate mode that moves a captured image around the display in response to the movement of device 4000 or the users finger. Finally, since most GUI and scrolling functions do not require the positional accuracy that scanning does, the indications of displacement produced by navigation sensors 4008 or 4010 may be downsampled. This would reduce the compute requirements associated with handling the indications of displacement when an image was not being captured.

Although several specific embodiments of the invention have been described and illustrated, the invention is not to be limited to the specific forms or arrangements of parts so described and illustrated. The invention is limited only by the claims.

1. An electronic device, comprising:
a display, wherein an image is displayable on said display; and
a navigation sensor, whereby a movement of said electronic device relative to a surface in close proximity to said navigation sensor is sensed by said navigation sensor and said movement includes moving said display and said movement produces a change in said image that is showing on said display.

2. The electronic device of claim 1 wherein said change comprises at least moving a cursor.

3. The electronic device of claim 1 wherein said change comprises at least panning at least part of said image that is showing on said display.

4. The electronic device of claim 1 wherein said change comprises at least scrolling at least part of said image that is showing on said display.

5. The electronic device of claim 1 wherein said change comprises at least navigating at least part of said image that is showing on said display.

6-7. (cancelled)

8 An electronic device, comprising:
a display; and
a navigation sensor fixedly coupled to said display whereby said navigation sensor detects a movement of said electronic device relative to a surface in close proximity to said navigation sensor and said movement includes movement of said display and an image displayed on said display is altered in response to said movement.

9. The electronic device of claim 8 wherein said image displayed on said display is altered in response to said movement by moving an image of a cursor.

10. The electronic device of claim 8 wherein said image displayed on said display is altered in response to said movement by panning a second image displayed on at least part of said display.

11. The electronic device of claim 8 wherein said image displayed on said display is altered in response to said movement by scrolling a second image displayed on at least part of said display.

12. The electronic device of claim 8 wherein said image displayed on said display is altered in response to said movement by showing a different part of a second image part of which is displayed on at least part of said display.

13-16. (cancelled)

17. A method of manipulating an image displayed by a device on a display, said method comprising:
moving the entire device including said display relative to a surface upon which said device is placed;
detecting movement of said entire device relative to said surface; and
manipulating said image based on said movement.

18. The method of claim 17, further comprising moving a cursor displayed on said display.

19. The method of claim 17, further comprising scrolling at least part of said image displayed on said display.

20. The method of claim 17, further comprising panning at least part of said image displayed on said display.

21. The method of claim 17, further comprising showing a different part of a second image at least part of which is displayed on said display.

22. A method of manipulating an image displayed on a display, said method comprising:
detecting a movement of a device that includes said display fixedly coupled to said device, wherein said movement is detected relative to a surface adjacent said device; and
altering said image in response to said movement.

23. The method of claim 22, further comprising moving a cursor displayed on said display.

24. The method of claim 22, further comprising scrolling at least part of said image displayed on said display.

25. The method of claim 22, further comprising panning at least part of said image displayed on said display.

26. The method of claim 22, further comprising showing a different part of a second image at least part of which is displayed on said display.

27-31. (cancelled)

32. A method of previewing a scanned image, said method comprising:
displaying a first part of a scanned image on a display; and
displaying a second part of said scanned image in response to relative movement between a scanning device and a surface in close proximity to said scanning device, said scanning device and said display being fixedly coupled to each other.

33. The method of claim 32 wherein said second part of said scanned image is scrolled in relation to said first part of said scanned image.

34. The method of claim 32 wherein said second part of said scanned image is panned in relation to said first part of said scanned image.

35. The method of claim 32 wherein said second part of said scanned image is displaced in two directions in relation to said first part of said scanned image.

36-42. (canceled)

43. An electronic device-, comprising:
a display located on a first side of said electronic device;
a navigation sensor located on a second side of said electronic device, said second side being opposite said first side, wherein said navigation sensor detects a movement of a part of a user relative to said navigation sensor located in close proximity to said navigation sensor, and wherein an image displayed on said display is altered in response to said movement of said part of said user relative to said navigation device.

44. The electronic device of claim 43 wherein said image displayed on said display is altered in response to said movement by moving an image of a cursor.

45. The electronic device of claim 43 wherein said image displayed on said display is altered in response to said movement by panning a second image displayed on at least part of said display.

46. The electronic device of claim 43 wherein said image displayed on said display is altered in response to said movement by scrolling a second image displayed on at least part of said display.

47. The electronic device of claim 43 wherein said image displayed on said display is altered in response to said movement by showing a different part of a second image part of which is displayed on at least part of said display.

48. The electronic device of claim 43 further comprising:
a first button, whereby said movement of said part of said user and said first button may be operated in cooperation to mimic at least one function of a computer mouse being used with a graphical user interface.

49. The electronic device of claim 48 wherein a graphical user interface is being displayed on said display.

50. The electronic device of claim 48 further comprising:
a second button, whereby said movement of said part of said user, said first button, and said second button may be operated in cooperation to mimic more than one function of a computer mouse being used with a graphical user interface.

51. The electronic device of claim 50 wherein a graphical user interface is being displayed on said display.

52-56. (canceled)
